(19) United States
(12) Patent Application Publication
(10) Pub. No.: US 2016/0217014 A1
(43) Pub. Date: Jul. 28, 2016

(54) Task Distribution in Peer to Peer Networks

(71) Applicant: HEWLETT PACKARD ENTERPRISE DEVELOPMENT LP, Houston, TX (US)

(72) Inventor: Chris Davenport, Houston, TX (US)

(21) Appl. No.: 14/916,092

(22) PCT Filed: Sep. 26, 2013
(86) PCT No.: PCT/US2013/061908

§ 371 Date: Mar. 2, 2016

(51) Int. Cl. G06F 9/50; H04L 29/08

(52) U.S. Cl. CPC G06F 9/5088; H04L 67/1074

(57) ABSTRACT

For each pairwise permutation comprising a first and second node of a plurality of nodes in a peer to peer network, the second node may be a peer node of the first node if a distance between the first and second nodes is closer than a distance between the first node and any other node that has a same range as a range between the first and second nodes. The instructions to perform and distribute a task may be sent from a root node of the plurality of nodes to each of its peer nodes. For each of the nodes other than the root node, the instructions may be received by each of the peer nodes of the each node if the range between the each node and the each peer node is less than the range between the each node and the node from which the instructions were received.

### BACKGROUND

In peer to peer (P2P) networks, which may be decentralized and distributed network architectures, individual nodes may be both suppliers and consumers of resources. This is in contrast to the centralized client-server model where nodes request access to resources provided by central servers. Thus, in such distributed networks, tasks may be shared amongst multiple nodes that each make a portion of their resources, such as processing power, disk storage or network bandwidth, directly available to other nodes, without need for centralized coordination by servers.

### BRIEF DESCRIPTION OF THE DRAWINGS

Some examples are described with respect to the following figures:

FIG. 1 is a flow diagram illustrating a method of distributing a task to each node in a peer to peer network according to some examples;

FIG. 2 is a schematic illustration of peer to peer network according to some examples;

FIG. 3 is a flow diagram illustrating a method of generating a list of peer nodes for each node in a peer to peer network according to some examples;

FIGS. 4-5 are each a schematic illustration of a peer to peer network in which a list of peer nodes of a node in the peer to peer network is generated according to some examples;

FIG. 5 is a schematic illustration of a peer to peer network in which list of peer nodes of each node in the peer to peer network of FIG. 4 is generated according to some examples;

FIGS. 6-8 are each a schematic illustration of a peer to peer network in which a list of peer nodes of a node in the peer to peer network is generated according to some examples;

FIG. 9 is a schematic illustration of a peer to peer network in which the lists of peer nodes of FIGS. 6-8 of each node in the peer to peer network is generated according to some examples;

FIG. 10 is a flow diagram illustrating a method of distributing a task to each node in a peer to peer network according to some examples; and

FIGS. 11-12 are each a schematic illustration of a peer to peer network in which a task is distributed to a plurality of nodes in the peer to peer network according to some examples.

### DETAILED DESCRIPTION

Before particular examples of the present disclosure are disclosed and described, it is to be understood that this disclosure is not limited to the particular examples disclosed herein as such may vary to some degree. It is also to be understood that the terminology used herein is used for the purpose of describing particular examples only and is not intended to be limiting, as the scope of the present disclosure will be defined only by the appended claims and equivalents thereof.

Notwithstanding the foregoing, the following terminology is understood to mean the following when recited by the specification or the claims. The singular forms “a,” “an,” and “the” are intended to mean “one or more.” For example, “a processor” includes reference to one or more processors. Further, the terms “including” and “having” are intended to have the same meaning as the term ‘comprising’ has in patent law. Also, the term “couple” or “couples” is intended to mean either an indirect or direct electrical connection. Thus, if a first device couples to a second device, that connection may be through a direct electrical connection, or through an indirect electrical connection via other devices and connections. A “node” is defined herein to be a computing device in a peer to peer network.

Many systems have a large number of nodes, each of which may execute a given task or a portion of a task. However, such systems may be inefficient, and may have nodes that over-communicate with each other, and/or may operate based on stale information regarding which nodes are online. Accordingly, the present disclosure concerns peer to peer networks, computer-readable media, and methods of distributing a task. In some examples, tasks may be distributed to the nodes in a peer to peer network, and results may be collected from the nodes, in ways that scale well to systems of any number of nodes including large numbers. In some examples, communication between nodes and thus processing overhead may be minimized by load balancing the workloads of nodes, and information regarding which nodes are online may, for example, always be up to date, thus tasks may quickly be correctly distributed. In some examples, each node may receive the task once, thus it may be unnecessary to instruct nodes not to execute a task more than once. Additionally, the disclosure herein may be implemented such that there may be no single point of failure in the system, thus it may be robust to single node failures.

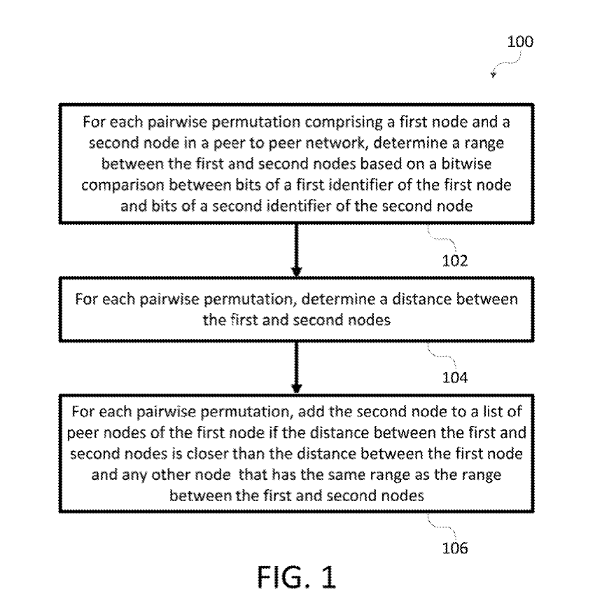

FIG. 1 is a flow diagram illustrating a method 100 of distributing a task to each node in a peer to peer network according to some examples. The method 100 may be computer-implemented. For each pairwise permutation comprising a first node and a second node of a plurality of nodes in a peer to peer network, the second node may be a peer node of the first node if a distance between the first and second nodes is closer than a distance between the first node and any other node of the plurality of nodes that has a same range as a range between the first and second nodes. The term “each pairwise permutation comprising a first node and a second node of a plurality of nodes in a peer to peer network” is defined herein to include any permutation of two different nodes in the peer to peer network. This includes different permutations which are the same combination, such as {node 1, node 2} and {node 2, node 1 }. For example, if the peer to peer network has 16 nodes n, then there may be n!/(n−r)! =240 pairwise permutations, where r=2 represents the number nodes in each pair.

At block 102, instructions to perform and distribute a task may be sent from a root node of the plurality of nodes to each of the peer nodes of the root node. At block 104, for each of the nodes other than the root node, the instructions may be received by each of the peer nodes of the each node if the range between the each node and the each peer node is less than the range between the each node and the node from which the instructions were received.

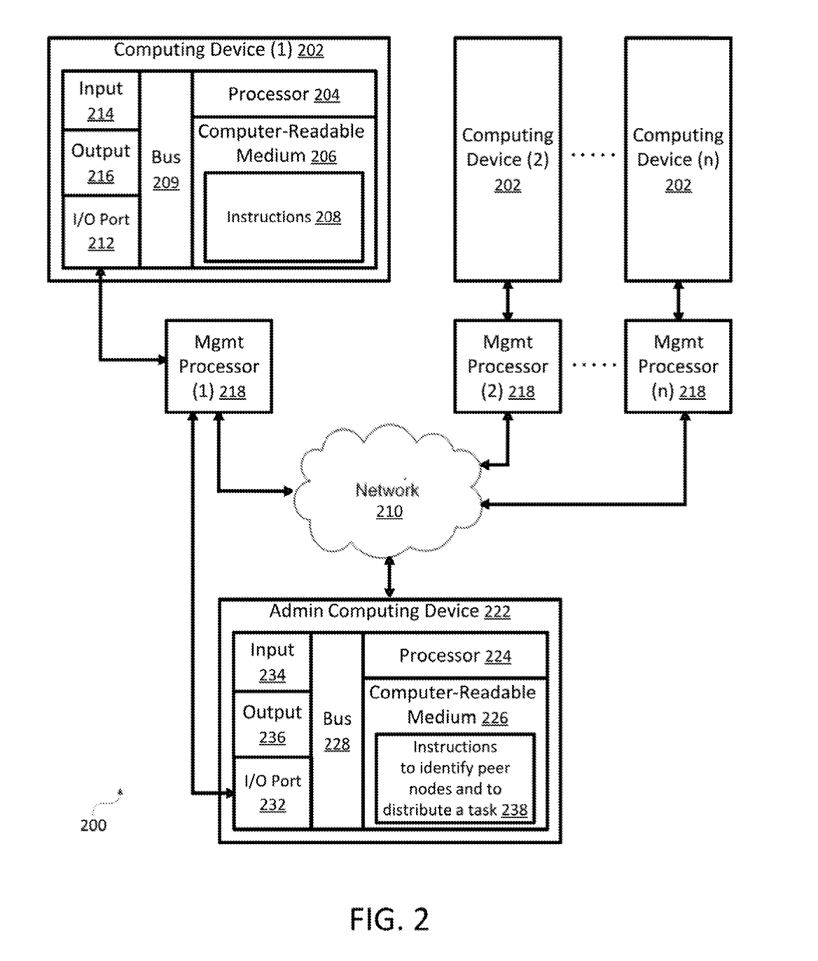

FIG. 2 is a schematic illustration of a system 200 according to some examples. Any of the operations and methods disclosed herein may be implemented and controlled in the system 200. The system 200 may be a peer to peer network, and may include a plurality of n nodes, such as n computing devices 202, as shown. The number n may, for example, be in the tens or in the thousands. Each computing device 202 may be a desktop computer, a laptop computer, a personal digital assistant (PDA), a cell phone, a smart phone, or other computing device. In some examples, the peer to peer network may be implemented as a distributed hash table (DHT).

Each computing device 202 may include a processor 204. The processor 204 may, for example, be a microprocessor, a microcontroller, a programmable gate array, an application specific integrated circuit (ASIC), a computer processor, or the like. The processor 204 may, for example, include multiple cores on a chip, multiple cores across multiple chips, multiple cores across multiple devices, or combinations thereof. In some examples, the processor 204 may include at least one integrated circuit (IC), other control logic, other electronic circuits, or combinations thereof.

The processor 204 may be in communication with a computer-readable storage medium 206 via a communication bus 209. The computer-readable medium 206 may include a single medium or multiple media. For example, the computer readable medium 206 may include one or both of a memory of the ASIC, a system memory in the computing device 202, and a firmware storage medium in the computing device 202. The computer readable medium 206 may be any electronic, magnetic, optical, or other physical storage device. For example, the computer-readable storage medium 206 may be, for example, random access memory (RAM), static memory, read only memory, an electrically erasable programmable read-only memory (EEPROM), a hard drive, an optical drive, a storage drive, a CD, a DVD, and the like. The computer-readable medium 206 may be non-transitory. The computer-readable medium 206 may store, encode, or carry computer executable instructions 208 that, when executed by the processor 204, may cause the processor 204 to perform any one or more of the methods or operations disclosed herein according to various examples.

Each computing device 202 may include user input devices 214 coupled to the processor 202, such as one or more of a keyboard, touchpad, buttons, keypad, dials, mouse, track-ball, card reader, or other input devices. Each computing device 202 may include output devices 216 coupled to the processor 202, such as one or more of a liquid crystal display (LCD), printer, video monitor, touch screen display, a light-emitting diode (LED) or other output devices. Thus, each computing device 202 may support direct user interaction. In some examples, each computing device 202 may not support direct user interaction, for example it may be a headless server that may instead be accessible via other devices. Each computing device 202 may include an input/output (I/O) port 212 to connect to another device.

Each computing device 202 may include a management processor 218, e.g. a baseboard management controller, which may be internal or external to the computing device 202. In some examples, the management processor 218 may have similar components as the processor 204. Additionally, in some examples, the management processor 218 may remain powered and active even when the processor 204 is powered-off. In some examples, the management processor 218 may be a stand-alone processor, while in other examples, the management processor 218 may be an application specification integrated circuit (ASIC) having at least one processor core, and other components, such as memory and network interface devices. In some examples, the management processor 218 may be formed from a plurality of individual components grouped together physically, such as on a circuit board coupled within the computing device 202. In some examples, the management processor 218 may not be independent from the processor 204, in that the processor 204 may perform all the management tasks described herein that are otherwise performed by an independent management processor 218.

The management processor 218 may be coupled to and may be able to access the computer-readable medium 206, which as discussed earlier may include a firmware storage medium. Additionally, the management processor 218 may include multiple internal network interface controllers, such as to enable the management processor 218 to couple to the network 210. Thus, each computing device 202 may be in communication with an administrator computing device 222 though the management processor 218. The administrator computing device 222 may communicate with each management processor 218 and the computing device 202 over the network 210 or over a direct connection to the management processor 218, such as through the input/output (I/O) port 232 of the administrator computing device 222.

The network 210 may, for example, be a local area network (LAN), wide area network (WAN), the Internet, or any other network. Data transferred from the administrator computing device 222 to the management processor 218 may be converted from one communication protocol, e.g., a network protocol such as TCP/IP, to another communication protocol (e.g., a USB protocol, for use by the computing device 202. The network 210 may be a management network, for example to be used for forwarding management tasks. In some examples, the network 210 may be used for general purpose communications between the computing devices 202 as well.

The administrator computing device 222 may include similar components as the computing device 202. It may include a processor 224 similar to the processor 204, a computer-readable medium 226 similar to the computer-readable medium 206, an input device 234 similar to the input device 214, an output device 236 similar to the output device 216, and a bus 228 similar to the bus 209. In some examples, rather than including a separate administrator computing device 222, the system 200, the system 200 may instead allow any of the computing devices 202 to operate the administrator functionality described herein. In some examples, the administrator computing device 222 may be run virtually in one or more of the computing devices 202.

The processor 224 may be coupled to the computer readable medium 226, which may store executable instructions 238, such as management instructions. The instructions 238, when executed by a processor, may cause the processor to perform any one or more of the methods or operations disclosed herein according to various examples. For example, when executed by the processor 224, the instructions 238 may cause the administrator computing device 222 to communicate with and may include instructions for nodes to generate lists of peer nodes and to distribute a “task”, which is any operation to be performed on one or more computing device 202. In some examples, the instructions 238 may include instructions for the management processor 218 to perform the task on its computing device 202.

In some examples, the instructions 238 may be for a “management task”, which is a task for managing resources of a computing device 202. Examples of management tasks include, but are not limited to firmware updating, console redirection, temperature monitoring, fan control/monitoring, remote power management, and remote media redirection. As an example, the management instructions 238 may cause the administrator computing device 222 to monitor the operation and performance of the computing device 202. If the computing device 202 is a “headless” device such as a server, the management instructions 238 may cause the administrator computing device 222 to display information regarding the condition of the computing device 202 to an administrator. The administrator computing device 222 and peripheral devices of the administrator computing device 222 (e.g., a floppy drive, a CD-ROM drive) may, for example, control the reboot process of the computing device 202 if an emergency or maintenance condition occurs. Additionally, the management instructions 238 may cause the administrator computing device 222 to provide updates, drivers, documentation or other types of support information to the computing device 202. Such support information may be provided to the computing device 202 upon request or during a scheduled or random maintenance operation provided by the administrator computing device 222 and involving the computing device 202.

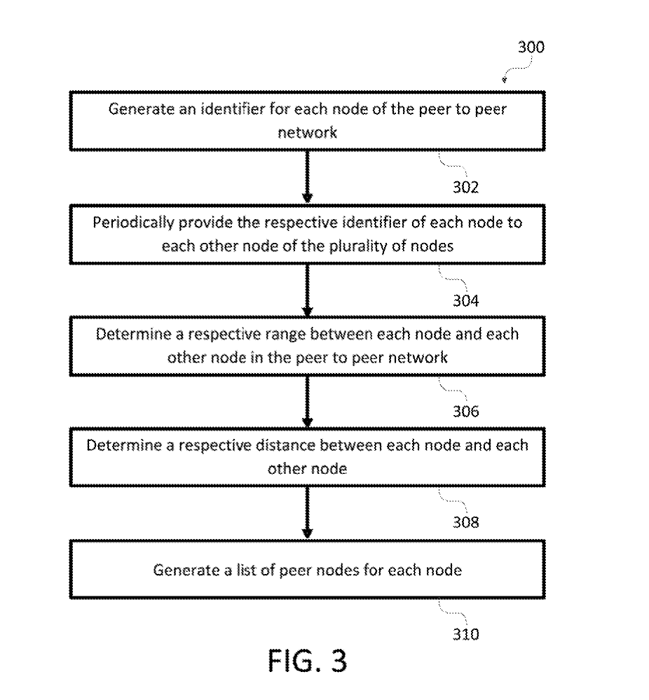

FIG. 3 is a flow diagram illustrating a method 300 of generating a list of peer nodes for each node in a peer to peer network according to some examples. The method may be computer-implemented, for example by one or more of the elements of FIG. 2. In some examples, the ordering shown may be varied, such that some steps may occur simultaneously, some steps may be added, and some steps may be omitted.

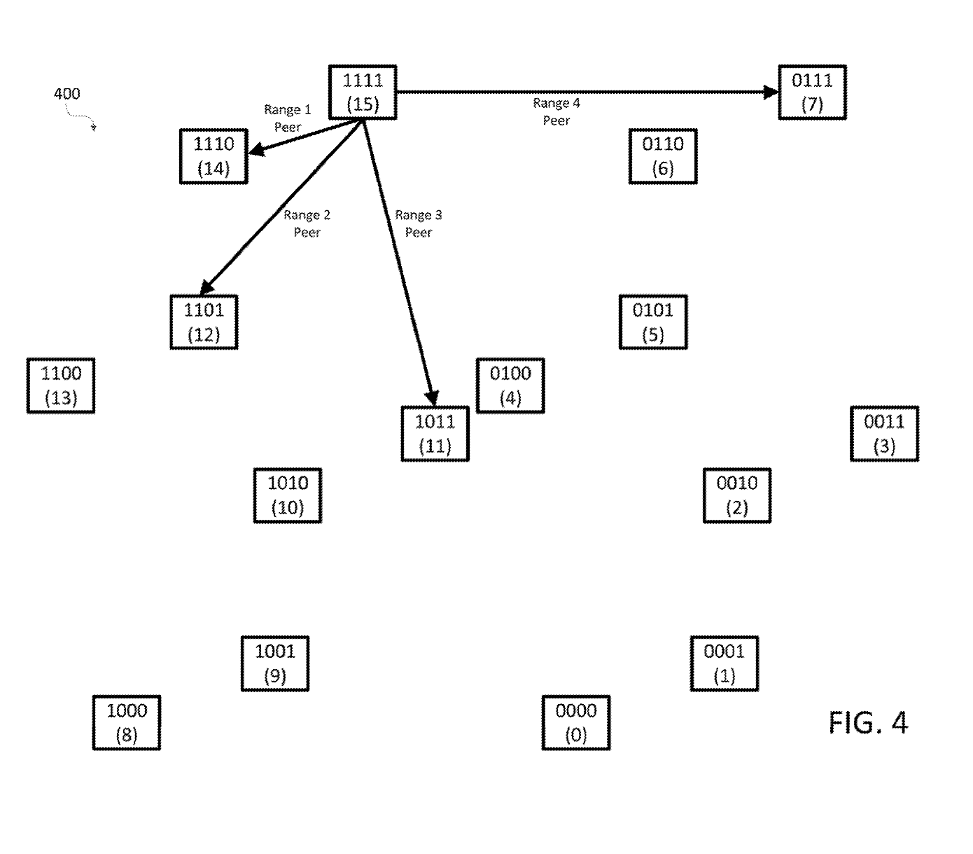

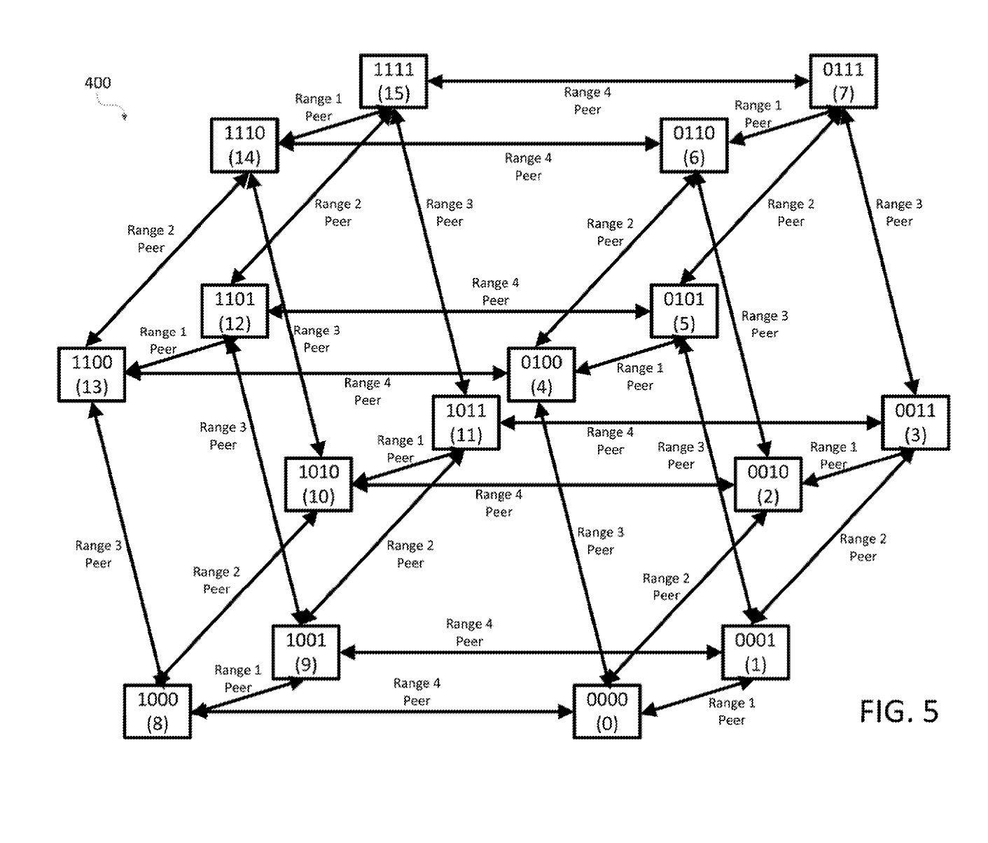

In describing FIG. 3, reference will be made to FIG. 2, FIG. 4, which is a schematic illustration of a peer to peer network 400 in which a list of peer nodes of a node in the peer to peer network 400 is generated according to some examples, and FIG. 5, which is a schematic illustration of the peer to peer network 400 in which a list of peer nodes of each node in the peer to peer network 400 is generated according to some examples. The peer to peer network 400 may include similar elements as the peer to peer network 200 of FIG. 2. Each node may be one of the n management processors 218 of FIG. 2, one of the n computing devices 202 of FIG. 2, or one of the n processors 204 of FIG. 2, for example.

At block 302, an identifier may be generated and/or provided for each node of the peer to peer network. In some examples, the node itself may generate its identifier, or in other examples, a separate server, such as the admin computing device 222 or one of the other nodes, may generate the identifier. The identifier may include a node address having one or more node identifier bits identifying the node.

The identifier may be a unique identifier. In some examples, the node address may be a host address or a network interface address. For example, the identifier may be the media access control address (MAC address) of a network interface of the node. The MAC address may, for example, be 48-bit number. In other examples, the identifier may be a unique identifier such as a universally unique identifier (UUID). A UUID may, for example, be a 128-bit number. The UUID may be generated by the node by a hash function such as, for example, the SHA-1 hash function. Use of a unique identifier such as a UUID may allow for unique identification of nodes without central coordination.

Given that a unique identifier such as the UUID is finite in size, each unique identifier may, for example, not necessarily be guaranteed to be unique. Thus, the term “unique” as used in the claims is intended to mean that each unique identifier may be substantially unique in that it is improbable that any other unique identifier in the peer to peer network has the same unique identifier.

At block 304, each node may identify itself by notifying other nodes in the peer to peer network of its presence. For example, each node may provide a message to the other nodes, where the message may include the node's identifier. For example, if there are sixteen nodes, then each of the sixteen nodes may send a message to the other fifteen nodes, and each node may receive fifteen messages from the other fifteen nodes.

The message may be sent as a broadcast or a multicast, for example. Each node may include a signature in its message. The signature may be known to other nodes, such that the other nodes can verify the authenticity of the message. Thus, the nodes may not be susceptible to disruption due to false messages such as by imposter nodes. Each node may send its message periodically, as long as it is online. In some examples, online nodes may send respective messages substantially at the same time, and after a given time interval such as a periodic interval, online nodes may again send respective messages substantially at the same time, and so on. When the node goes offline, it may no longer send a message.

In some examples, it may be possible that identifiers may be duplicated. However, when using larger identifiers such as 128-bit identifiers, duplication may be unlikely, because some or most node identifiers may be not used by any node. For example, a 128-bit identifier allows for 2̂128=3.4e38 identifiers, which may be over 30 orders of magnitude greater than the number of nodes in a given peer to peer network.

However, in a rare case that duplication occurs between identifiers, remedial steps may be taken. For example, upon receiving messages with the identifiers from other nodes, a node may discover that it shares an identifier with one of the other nodes. The node may not participate in the following steps to generate a list of peer nodes. Instead, the node may generate a new identifier, and may participate in the next periodic notification process described in step 304. If at that time the node has a unique identifier, then the node may participate in the following steps. Meanwhile, nodes other than the duplicate nodes may treat the duplicate nodes as offline when performing the following steps.

At blocks 306 to 310, ranges and distances between nodes may be determined, and based on the ranges and distances, a lists of peer nodes may be generated. These steps may be performed periodically so as to continually update the lists of peer nodes, given that nodes may enter or exit the peer to peer network. For example, these steps may be performed by each node after the broadcast message of step 304 is sent by all nodes.

At block 306, based on the broadcasted identifiers, each node may determine a respective range between itself and each other node in the peer to peer network. Each “range” is a value representing a different respective grouping of node relationships. Thus, if two nodes have a range between them, this means that the node relationship between the two nodes falls within one of the groupings. The ranges may be organized in a hierarchy, e.g. a ranked set of ranges.

This determination of a range may be performed by a bitwise comparison of one or more bits the two node identifiers. For example, the range between two nodes may be equal to n if the nth bit from the least significant bit, e.g. the lowest bit which may be counted from the right, is the first bit to differ between the node identifiers of the two nodes. In some examples, the counting may be from the most significant bit, e.g. the highest bit which may be counted from the left. Additionally, in some examples, the identifiers may be coded in the opposite direction, such that least significant bit may be on the right.

To illustrate counting from the least significant bit on the right, a simplified example will be described having 16 nodes in which each identifier includes 4 bits, which allow for 2̂4=16 unique identifiers. Thus, each unique identifier is populated by a node. The range X nodes of node 1111 may be the following. The range 1 node may be node 1110. Range 2 nodes may include all nodes 110x, i.e. nodes 1101 and 1100. Range 3 nodes may include all nodes 10xx, i.e. nodes 1011, 1010, 1001, and 1000. Range 4 nodes may include all nodes 0xxx, i.e. nodes 0111, 0110, 0101, 0100, 0011, 0010, 0001, and 0000. Thus, there may be four groups of node relationships ranked as a hierarchy, namely ranges 1 to 4.

At block 308, based on the broadcasted identifiers, each node may determine a respective distance between itself and each other node in each range. The “distance” is a value representing a numerical difference between the two identifiers of two nodes. The distance may be calculated in a number of different ways. The following describes some examples.

The distance may be computed by a bitwise operation between the node identifiers, such as an exclusive or (XOR) operation. An XOR operation is a bitwise operation that outputs true if both inputs differ, and outputs false if both inputs are the same. In the case of binary bits, an XOR between 1 and 0 or between 0 and 1 equals 1, and an XOR between 1 and 1 or between 0 and 0 equals 0.

In some examples, the XOR operation may be performed between all bits of the two nodes undergoing to the XOR operation. Thus, an XOR operation between node 1111 and range 3 node 1010 may result in a distance of 1 in binary and 1 in decimal.

In other examples, the XOR operation may be performed between the lowest Y number of bits of the nodes, where the value Y may be equal to the range value minus one. For example, an XOR operation between node 1111 and range 3 nodes 10xx may involve an XOR operation between Y=range−1=2 lower bits. Thus, the distance between node 1111 and the range 3 node 1010, may be calculated, for example, by performing an XOR operation between 11 and 10, resulting in a distance of 10 in binary, i.e. 2 in decimal. The range 1 node may not have a distance, as no further information may be necessary to identify the single range 1 node. These examples may involve fewer bitwise comparisons than performing the XOR operation on all bits.

Table 1 summarizes the ranges and distances of each node from the perspective of node 1111, including distances calculated according an the XOR operation performed between all bits of the two nodes, and according to an XOR operation performed between the lowest X number of bits of the nodes, as discussed earlier. Binary and decimal values are shown for identifiers and distances, and decimal values are shown for ranges. In decimal, node 1111 is node 15.

TABLE 1

| | | Distance: | Distance: |
|---|---|---|---|
| Node Identifier | | XOR all bits | XOR (range-1) |
| (binary and | | (binary and | bits (binary and |
| decimal) | Range (decimal) | decimal) | decimal) |
| 1110 (14) | 1 | 1 (1) | N/A |
| 1101 (13) | 2 | 10 (2) | 0 (0) |
| 1100 (12) | 2 | 11 (3) | 1 (1) |
| 1011 (11) | 3 | 100 (4) | 0 (0) |
| 1010 (10) | 3 | 101 (5) | 1 (1) |
| 1001 (9) | 3 | 110 (6) | 10 (2) |
| 1000 (8) | 3 | 111 (7) | 11 (3) |
| 0111 (7) | 4 | 1000 (8) | 0 (0) |
| 0110 (6) | 4 | 1001 (9) | 1 (1) |
| 0101 (5) | 4 | 1010 (10) | 10 (2) |
| 0100 (4) | 4 | 1011 (11) | 11 (3) |
| 0011 (3) | 4 | 1100 (12) | 100 (4) |
| 0010 (2) | 4 | 1101 (13) | 101 (5) |
| 0001 (1) | 4 | 1110 (14) | 110 (6) |
| 0000 (0) | 4 | 1111 (15) | 111 (7) |

At block 310, using the range and distance calculations, a list of peer nodes may be generated for each node. Thus, the number of lists of peer nodes generated may be equal to the number of nodes in the peer-to-peer network. Each node may generate its own list of peer nodes, or other components in the peer to peer network 200 may generate the node's list of peer nodes. As shown in FIG. 5, the lists together constitute a balanced graph, i.e. balanced tree structure, in that the relationships between the nodes may take on distributed substantially evenly throughout the peer to peer network 400.

A “list” is understood herein to be any type of data identifying peer nodes of a given node. For example, each list may be generated and stored in any format, for example in a data array or data set of any kind, such as in multiple separate data files.

A “peer node” is a closest node for a given range X. Thus, the given node's list of peer nodes may comprise the closest nodes in each range X. In some examples, log2(n) peers may be kept, one for each range, where n is the number of nodes. A first node may be “closer” to a second node than a third node if the distance between the first and second nodes has a lower numerical value than the distance between the first and third nodes. However, the definition of “closer” is meant to encompass other conventions such as a higher numerical value corresponding a closer distance.

As shown in FIG. 4, the list of peer nodes for node 1111 may comprise 4 members, including one for each range X: (1) node 0111, the lowest distance range 4 node, (2) node 1011, the lowest distance range 3 node, (3) node 1101, the lowest distance range 2 node, and (4) node 1110, the lowest distance range 1 node and/or only range 1 node. Because a list of peer nodes may be generated for each node, there may be 16 lists of peer nodes each having 4 members. FIG. 5 shows sixteen superimposed lists of peer nodes, respectively of each of the sixteen nodes. To simplify the illustration, double arrows are shown for two-way peer relationships. For example, nodes 0111 may be a member of node 1111's list of peer nodes, and conversely, node 1111 may be a member of node 0111's list of peer nodes.

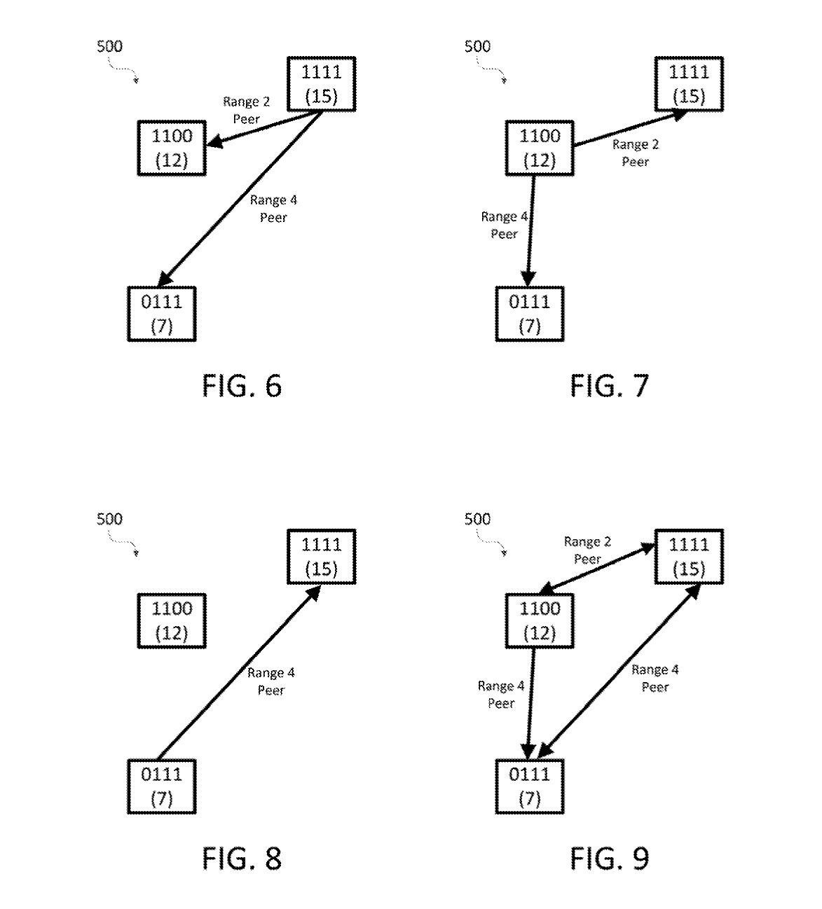

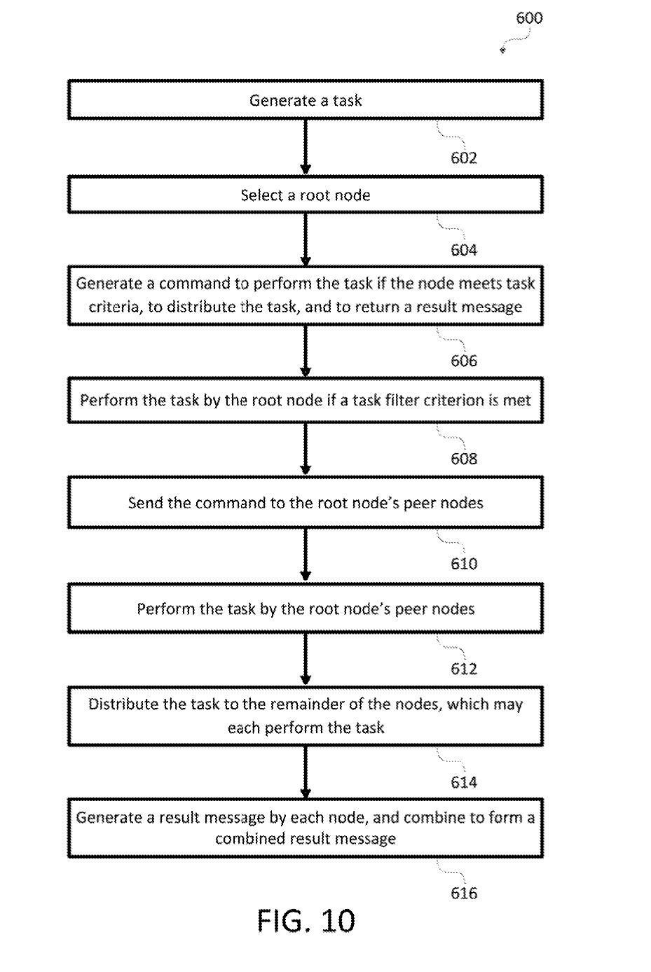

Each of FIGS. 6-8 is schematic illustration of a respective peer to peer network 500, in which a list of peer nodes of a node in the peer to peer network 500 is generated according to some examples, and FIG. 9 is a schematic illustration of the peer to peer network 500 in which the lists of peer nodes of FIGS. 6-8 of each node in the peer to peer network 500 is generated according to some examples. The peer to peer networks 500 may include similar components as the peer to peer network 200 of FIG. 2.

These examples illustrate generating lists of peer nodes where the number of nodes is fewer than the number of available identifiers. An example will be illustrated in which the 4-bit identifiers are used, but only 3 nodes are present, namely nodes 1111, 1100, and 0111. For example, the lists of peer nodes of FIG. 5 may be current until 13 nodes go offline, leaving only nodes 1111, 1110, and 0111. In this case, after each node has broadcasted its presence, each node 1111, 1110, and 0111 may recognize that, aside from itself, only the two others are present. Thus, the lists of peer nodes of FIG. 9 may be generated to replace of lists of peer nodes of FIG. 5.

The lists of peer nodes may be generated according to the same rules as described earlier. In FIG. 6, node 1111 lists node 1100 as its range 2 peer node and lists node 0111 as its range 4 peer node. In FIG. 7, node 1100 lists node 1111 as its range 2 peer node and lists node 0111 as its range 4 peer node. In FIG. 8, node 0111 lists node 1111 as its range 4 peer node but does not list node 1100 as a peer node because it is a more distant range 4 node than node 1111.

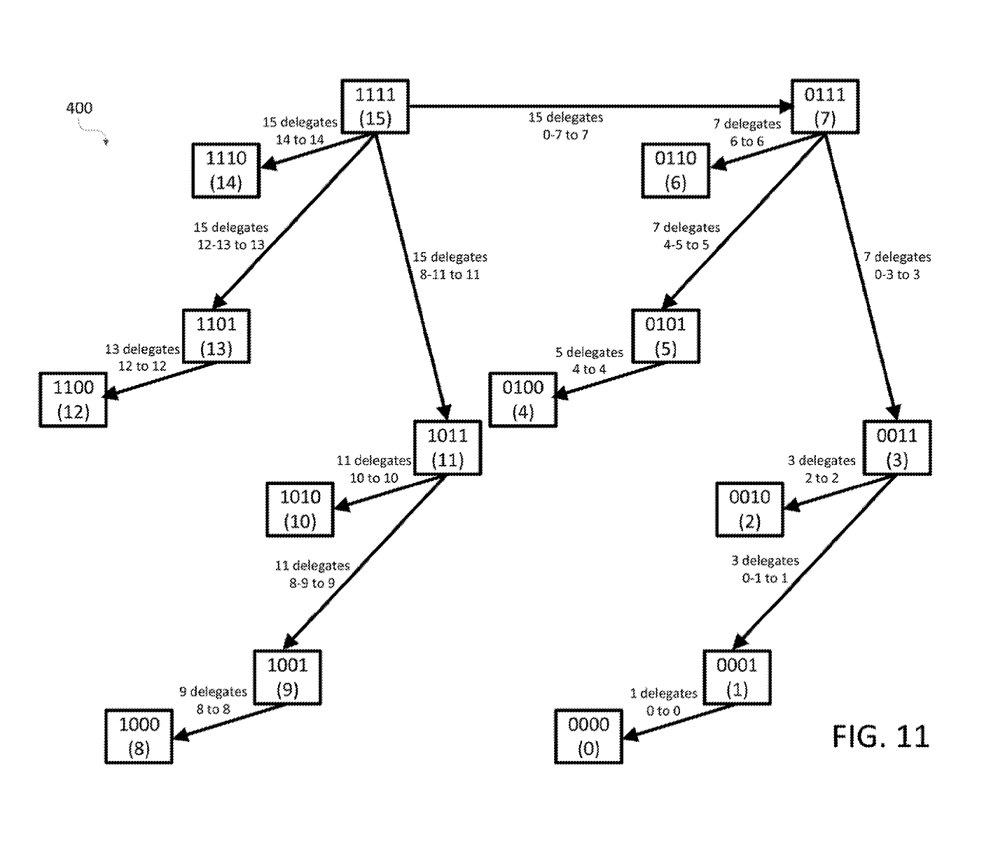

FIG. 10 is a flow diagram illustrating a method 600 of distributing a task to each node in a peer to peer network according to some examples. The method may be computer-implemented, for example by one or more of the elements of FIG. 2. In some examples, the ordering shown may be varied, such that some steps may occur simultaneously, some steps may be added, and some steps may be omitted.

In describing FIG. 10, reference will be made to FIGS. 2-5 and FIG. 11, which is a schematic illustration of the peer to peer network 400 in which a task is distributed to a plurality of nodes in the peer to peer network 400 according to some examples.

At block 602, a task may be generated by the administrator computing device 222, or by a node in the peer to peer network 400, for example. The task may be a management task, as discussed earlier. In some examples, the task may be generated based on a user input to the input device 234 and/or based on instructions 238 for performing tasks on the nodes in the peer to peer network 400. In some examples, the instructions 238 may be for management tasks to be performed periodically on the nodes, or in response to a request from one or more of the nodes. For example, a node may instruct the administrator computing device 222 that there is a problem in the peer to peer network that needs be addressed by performance of a task by the nodes.

At block 604, one node in the peer to peer network 400 may be selected to be a “root node”, which is the initial node to process instructions to perform and distribute the task. In some examples, the administrator computing device 222 may select a node in the peer to peer network as the root node. In some examples in which the administrator computing device 202 is itself a node, the administrator computing device 202 may select itself as the root node. In some examples, the selection of the root node may be based on a user input to the input device 234, may be random, or may be based on the administrator computing device 202's knowledge of resources available to the various nodes.

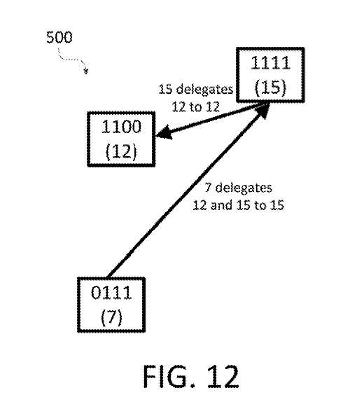

The example of FIG. 11 shows sixteen nodes having node identifiers in the binary bit format xxxx, as in the example of FIGS. 4-5. The lists of peer nodes for the peer to peer network 400 may have been generated as in the peer to peer network 500 of FIG. 5. In FIG. 11, node 1111 is selected as the root node. However, in other examples, any of the other fifteen nodes may selected as the peer node.

At block 606, a command may be generated by the administrator computing device 202. In examples in which the administrator computing device 202 is not the root node, the command may be sent to the root node. For example, in FIG. 11, root node 1111 may generate the command or receive the command from the administrator computing device 202. The command may comprise the following instructions.

First, each node may be instructed to perform the task if the node meets one or more task filter criteria designated by task filter data. The “task filter criteria” are criteria based on which a node may determine whether to perform the task. A criterion for performing the task may, for example, be to install a latest version of firmware only if the latest version is not already installed on a node, or may be any other criterion to determine whether the task is to be performed on a node.

Second, each node may be instructed to distribute the task to peer nodes. For example, the instructions to distribute may comprise “range filtering” instructions for each node to send the command to its peer nodes with a range Y from itself that is less than the range X between itself and the node it received the command from, i.e Y<X. In some examples, the identifiers may be coded in the opposite direction, in which case the condition may be that range Y is greater than X, however this scenario is understood herein to be equivalent and thus encompassed by the condition of range Y being is “less than” the range X as discussed above. the is equivalent to the formulation in which Y is greater than X. The range filter may result in an efficient delegation of distribution of tasks and balanced workload for the nodes. Additionally, broad advertisement of the task by a single node to a large numbers of nodes may not be necessary, for example.

Third, each node may be instructed to generate, after attempting to perform the task, a result message indicating whether it and any of the nodes to which it delegated task distribution successfully performed the task. For example, the result message may indicate that the node and nay of the nodes to which it delegated task distribution (1) completed the task, (2) received but not complete the task due to one or more filter criteria, (3) received but not complete the task due to an error, or (4) did not send a result message due to an error. Each node may be instructed to return the result message to the node from which the command was received. Before returning the result message, each node may receive a respective result message from each of its peer nodes, and combine all result messages into a single message that may be sent to the node from which the command was received. In some examples, each node may wait a predetermined amount of time to receive result messages from peer nodes.

These features are further illustrated in the examples of the following steps.

At block 608, the root node may perform the task. For example, in FIG. 11, root node 1111 may be a management processor 218, which may perform the task on its computing device 202. Performance of the task may be subjected to the task filter.

At block 610, the root node may send, to each of its peer nodes, a command instructing them to perform the task and to each further distribute the task. Because the root node may not have received the command from any other node, the peer node may send the command to all peer nodes. For example, in FIG. 11, root node 1111 may send the command to each of its peer nodes, e.g. its range 1 peer node 1110, its range 2 peer node 1101, its range 3 peer node 1011, and its range 4 peer node 0111, each of which are delegated sending of commands to further nodes. Thus, the root node 1111 may be responsible for delegating to the entire peer to peer network, in that no other nodes will receive a command if the root node 1111 does not perform step 610.

At block 612, each peer node of the root node may perform the task. For example, in FIG. 11, each of the root node 1111's peer nodes 1110, 1101, 1011, and 0111 may perform the task. Performance of the task may be subjected to the task filter.

At block 614, commands may be distributed to the remainder of the nodes, which may each perform the task.

For example, each peer node of the root node may send a respective command regarding the task to each of its peer nodes with a range from itself that is less than the range between itself and the node it received the command from. As discussed earlier, the root node 1111's peer nodes, e.g. nodes 1110, 1101, 1011, and 0111, may each be a lowest distance range X node from the root node 1111.

Peer node 1110 has range 1 peer node 1111, range 2 peer node 1100, range 3 peer node 1010, and range 4 peer node 0110. The range between itself and the node 1111 which it received the command from is 1. Because node 1110 has no peer nodes with a range below 1, node 1110 may not send a command to any other nodes. Thus, node 1110 may only be given responsibility for itself, and may not be responsible for delegating to any other nodes.

Node 1101 has range 1 peer node 1100, range 2 peer node 1110, range 3 peer node 1001, and range 4 peer node 0110. The range between itself and the node 1111 which it received the command from is 2. Thus, node 1101 may send a command to range 1 peer node 1100, which may perform the task. Thus, node 1101 may be responsible for delegating to two nodes counting itself.

Node 1011 has range 1 peer node 1010, range 2 peer node 1001, range 3 peer node 1111, and range 4 peer node 0011. The range between itself and the node 1111 which it received the command from is 3. Thus, node 1011 may send a command to range 1 peer node 1010 and range 2 peer node 1001, each of which may perform the task. Thus, node 1011 may be responsible for delegating to four nodes counting itself.

Node 0111 has range 1 peer node 0110, range 2 peer node 0101, range 3 peer node 0011, and range 4 peer node 1111. The range between itself and the node 1111 which it received the command from is 4. Thus, node 0111 may send a command to range 1 peer node 0110, range 2 peer node 0101, and range 3 peer node 0011, each of which may perform the task. Thus, node 0111 may be responsible for delegating to eight nodes counting itself.

Each of the nodes 1100, 1010, 1001, 0110, 0101, and 0011 may then send the command to each of their peer nodes, and so on, until all nodes in the peer to peer network 400 have received a command and performed the task. This may be done, for example, according to the same process outlined above. The number of iterations needed may be no more than the number of bits in the identifiers, and in some examples, less than the number of bits in the identifier. Ultimately, the distribution path may form a tree structure.

In some examples, groups of commands may be sent in parallel in sequential time periods. For example, any commands between range 4 nodes may be sent in parallel, then any commands between range 3 nodes may be sent in parallel, and so on. In FIG. 1, node 1111 may send a command to node 0111 at a first time period. Then, node 1111 may send a command to node 1011, and node 0111 may send a command to node 0011, in parallel at a second time period, and so on. The time periods for distribution of commands to the all nodes in FIG. 11 is shown in Table 2.

TABLE 2

| Sending node | Receiving node | Range Between | |
|---|---|---|---|
| (binary and | (binary and | Sending and | |
| decimal) | decimal) | Receiving Node | Time Period |
| 1111 (15) | 0111 (7) | 4 | 1st |
| 1111 (15) | 1011 (11) | 3 | 2nd |
| 0111 (7) | 0011 (3) | 3 | 2nd |
| 1111 (15) | 1101 (13) | 2 | 3rd |
| 1011 (11) | 1001 (9) | 2 | 3rd |
| 0110 (7) | 0101 (5) | 2 | 3rd |
| 0011 (3) | 0001 (1) | 2 | 3rd |
| 1111 (15) | 1110 (14) | 1 | 4th |
| 1101 (13) | 1100 (12) | 1 | 4th |
| 1011 (11) | 1010 (10) | 1 | 4th |
| 1001 (9) | 1000 (8) | 1 | 4th |
| 0110 (7) | 0110 (6) | 1 | 4th |
| 0101 (5) | 0100 (4) | 1 | 4th |
| 0011 (3) | 0010 (2) | 1 | 4th |
| 0001 (1) | 0000 (0) | 1 | 4th |

At block 616, each node may generate a result message, as discussed earlier, and may return the result message to the node from which the command was received. Before returning the result message, each node may receive a respective result message from each of its peer nodes, and combine all result messages into a single message that may be sent to the node from which the command was received.

Thus, for example, the sending of the result messages may be the inverse of the distribution of FIG. 11. For example, node 1000 may send a result message to 1001. Node 1001 may combine its own result message with the result message of node 1000. Node 1001 may then send its combined result message to node 1011. Node 1011 may ultimately generate a combined result message containing results for itself and nodes 1010, 1001, and 1000. Node 1011 may then result its combined result message to root node 1111. Root node 1111 may receive result messages having results for all other nodes in the peer to peer to peer network 400, and thus may generated a combined result message representing all nodes in the peer to peer network 400. The root node 1111 may send the combined message to the administrator computing device 222, which may, for example, take further action based on the combined message.

FIG. 12 is a schematic illustration of the peer to peer network 500 in which a task is distributed to a plurality of nodes in the peer to peer network 500 according to some examples. This example illustrates distributing the task where the number of nodes is fewer than the number of available identifiers.

Node 0111 may, for example, be selected as the root node. Root node 0111 may perform the task, and send a command to its only peer node, i.e. range 4 peer node 1111.

Then, node 1111 may perform the task. Node 1111 has range 2 peer node 1100 and range 4 peer node 0111. The range between itself and the node 0111 which it received the command from is 4. Thus, node 1111 may send a command to range 2 peer node 1100 but not to range 4 peer node 0111. Thus, node 1111 may be responsible for delegating to two nodes counting itself.

Then, node 1100 may perform the task. Node 1100 has range 2 peer node 1111 and range 4 peer node 0111. The range between itself and the node 1111 which it received the command from is 2. Because node 1100 has no peer nodes with a range below 2, node 1100 may not send a command to any other nodes. Thus, node 1110 may only be given responsibility for itself, and may not be responsible for delegating to any other nodes.

Node 1100 may send a result message to node 1111. Node 1111 may combine its own result message with the result message of node 1100. Node 1111 may then send its combined result message to root node 0111, which may generate a combined result message representing all three nodes in the peer to peer network 500. The root node 0111 may send the combined message to the administrator computing device 222, which may, for example, take further action based on the combined message.

In the foregoing description, numerous details are set forth to provide an understanding of the subject disclosed herein. However, examples may be practiced without some or all of these details. Other examples may include modifications and variations from the details discussed above. It is intended that the appended claims cover such modifications and variations.

What is claimed is:

1. A computer-implemented method comprising:
wherein for each pairwise permutation comprising a first node and a second node of a plurality of nodes in a peer to peer network, the second node being a peer node of the first node if a distance between the first and second nodes is closer than a distance between the first node and any other node of the plurality of nodes that has a same range as a range between the first and second nodes,
sending, from a root node of the plurality of nodes to each of the peer nodes of the root node, instructions to perform and distribute a task; and
for each of the nodes other than the root node, receiving the instructions by each of the peer nodes of the each node if the range between the each node and the each peer node is less than the range between the each node and the node from which the instructions were received.

2. The computer-implemented method of claim 1 wherein the task comprises a management task and each of the nodes comprises a management processor.

3. The computer-implemented method of claim 1 further comprising, for one or more of the plurality of nodes, performing the task in response to the instructions.

4. The computer-implemented method of claim 3 wherein for each of the nodes, the task is performed if the each node meets a task filter criterion.

5. The computer-implemented method of claim 3 further comprising:
for each of the nodes, generating, in response to attempting to perform the task, a result message indicating whether the each node successfully performed the task; and
combining, in the root node, the result messages into a combined result message.

6. A non-transitory computer readable storage medium including executable instructions that, when executed by a processor, cause the processor to:
wherein for each pairwise permutation comprising a first node and a second node of a plurality of nodes in a peer to peer network, the second node being a peer node of the first node if a distance between the first and second nodes is closer than a distance between the first node and any other node of the plurality of nodes that has a same range as a range between the first and second nodes,
select one node of the plurality of nodes as a root node;
send, to each of the peer nodes of the root node, instructions to perform and distribute a task; and
for each of the nodes other than the root node, send, in response to receiving the instructions, the instructions to each of the peer nodes of the each node if the range between the each node and the each peer node is less than the range between the each node and the node from which the instructions were received.

7. The non-transitory computer readable storage medium of claim 6 wherein the task comprises a management task and each of the nodes comprises a management processor.

8. The non-transitory computer readable storage medium of claim 6 further comprising instructions to, for each of the nodes, perform the task if the each node meets a task filter criterion.

9. The non-transitory computer readable storage medium of claim 6 further comprising instructions to generate, for each of the nodes and in response to attempting to perform the task, a result message indicating whether the each node successfully performed the task.

10. The non-transitory computer readable storage medium of claim 9 further comprising instructions combine, in the root node, the result messages into a combined result message.

11. A peer to peer network comprising:
a plurality of nodes comprising a processor, wherein for each pairwise permutation comprising a first node and a second node of a plurality of nodes in a peer to peer network, the second node being a peer node of the first node if a distance between the first node and any other node of the plurality of nodes that has a same range as a range between the first and second nodes is further than a distance between the first and second nodes,
the processor to:
receive, from a root node of the plurality of nodes and by each of the peer nodes of the root node, instructions to perform and distribute a task; and
for each of the nodes other than the root node, send, in response to receiving the instructions, the instructions to each of the peer nodes of the each node if the range between the each node and the each peer node is less than the range between the each node and the node from which the instructions were received.

12. The peer to peer network of claim 11 wherein the task comprises a management task and each of the nodes comprises a management processor.

13. The peer to peer network of claim 11 wherein the processor is to, for one or more of the plurality of nodes, perform the task in response to the instructions.

14. The peer to peer network of claim 13 wherein for each of the nodes, the task is performed if the node meets a task filter criterion.

15. The peer to peer network of claim 13 wherein the processor is to:
for each of the nodes, generate, in response to attempting to perform the task, a result message indicating whether the each node successfully performed the task; and
combining, in the root node, the result messages into a combined result message.
